(19) United States
(12) Patent Application Publication
(10) Pub. No.: US 2007/0025019 A1
(43) Pub. Date: Feb. 1, 2007

(54) CARTRIDGE CASE AND DISC CARTRIDGE

(75) Inventors: Hiroshi KANEDA, Tokyo (JP); Masaru IKEBE, Tokyo (JP); Kenji HASHIZUME, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/459,534

(22) Filed: Jul. 24, 2006

(30) Foreign Application Priority Data
Jul. 26, 2005 (JP) 2005/215510

(51) Int. Cl. G11B 23/03

(52) U.S. Cl. 360/133

(57) ABSTRACT

A cartridge case is constructed so as to be capable of enclosing an information medium inside a cartridge main body that includes a first shell and a second shell and is formed by placing the first shell and the second shell on one another. Cylindrical convex portions, each of which has a positioning reference hole formed in a central portion thereof, are erected on an inner surface of a main plate of the first shell. Insertion holes that allow positioning pins to be inserted into the positioning reference holes of the cylindrical convex portions are formed in a main plate of the second shell.

### BACKGROUND OF THE INVENTION

1. Field of the Invention

The present invention relates to a cartridge case constructed of a first shell and a second shell so as to be capable of enclosing an information medium and to a disc cartridge constructed by enclosing a disc-shaped information medium inside the cartridge case.

2. Description of the Related Art

As one example of a disc cartridge equipped with this type of cartridge case, Japanese Laid-Open Patent Publication No. 2004-318930 discloses a disc cartridge constructed so that an inner shell, a shutter member, and a disc-shaped recording medium are enclosed inside an outer shell (i.e., a cartridge case). With this disc cartridge, the outer shell is constructed by a first shell (hereinafter also referred to as an “upper shell”) and a pair of second shells (hereinafter also referred to as “lower shells”), and by screwing both lower shells to the upper shell, a box-shaped case in which a disc-shaped recording medium or the like can be enclosed is formed. Four positioning portions for positioning the outer shell at a predetermined recording/reproducing position inside a disc drive are provided on this disc cartridge. More specifically, a first positioning portion (cutaway part) and a second positioning portion (reference hole) are formed on one of the lower shells and a third positioning portion (cutaway part) and a fourth positioning portion (reference hole) are formed on the other of the lower shells.

When the disc cartridge is loaded into the disc drive, the disc cartridge is moved inside the drive while being guided by a disc holder so that positioning pins are inserted inside the first and third positioning portions. Next, the disc cartridge is biased downward by a pressing spring provided on the disc holder. By doing so, the disc cartridge (cartridge case) is positioned inside the disc holder and movement of the disc cartridge inside the drive is restricted. Note that in a disc drive where the disc cartridge is positioned by positioning pins provided in a base unit, when the disc cartridge has been moved to the recording/reproducing position inside the drive, the disc cartridge is positioned inside the disc drive by inserting the positioning pins inside the second and fourth positioning portions.

### SUMMARY OF THE INVENTION

However, by investigating the conventional disc cartridge, the present inventors found the following problem. That is, with the conventional disc cartridge, the outer case (i.e., the cartridge case) is formed by screwing both lower shells to the upper shell. With this type of disc cartridge, in a state where the lower shells and the upper shell are fitted together during manufacturing (i.e., a state where both lower shells have been placed on the upper shell), the lower shells rattle slightly on the upper shell. Accordingly, when the lower shells have been screwed to the upper shell, the lower shells are sometimes attached to the upper shell in a slightly displaced state. More specifically, as shown in FIG. 10, with a conventional disc cartridge 1x, lower shells 7x and 8x are sometimes screwed to an upper shell 6x in a displaced state. Note that the displacement of the lower shells 7x and 8x with respect to the upper shell 6x has been exaggerated in FIG. 10.

With the conventional disc cartridge 1x, as described above, positioning portions (i.e., first to fourth positioning portions 16x to 19x) for positioning the disc cartridge 1x with respect to the disc drive (i.e., the recording/reproducing apparatus) are formed in the lower shells 7x and 8x. Accordingly, as shown in FIG. 10, when the lower shells 7x and 8x are displaced with respect to the upper shell 6x, the first to fourth positioning portions 16x to 19x become displaced from their correct positions. Since the disc cartridge 1x (i.e., the outer shell 2x) is positioned inside a recording/reproducing apparatus using the positioning portions 16x to 19x that are displaced, it becomes difficult to correctly carry out disc access to the disc-shaped recording medium inside the outer shell 2x. In this way, with the conventional disc cartridge 1x, there is the problem that since the lower shells 7x and 8x are displaced with respect to the upper shell 6x, it becomes difficult to correctly position the disc cartridge 1x with respect to the recording/reproducing apparatus.

Also, as shown in FIG. 10, in a state where the lower shells 7x and 8x are displaced with respect to the upper shell 6x, the width L2x of the outer shell 2x composed of the upper shell 6x and the lower shells 7x and 8x becomes wider than the standard range. This means that when the disc cartridge 1x is loaded into the recording/reproducing apparatus, there is the risk of the outer shell 2x (i.e., the lower shells 7x and 8x) contacting the disc holder and the like and making it difficult to smoothly load the disc cartridge 1x. In the same way, in a state where the lower shells 7x and 8x are displaced with respect to the upper shell 6x, the length L3x of the outer shell 2x becomes longer than the standard range. This means that there is the risk of it becoming difficult to reliably load the disc cartridge 1x to a recording/reproducing position inside the recording/reproducing apparatus.

The present invention was conceived in view of the problem described above and it is a principal object of the present invention to provide a cartridge case and a disc cartridge that can be correctly positioned inside a recording/reproducing apparatus or the like. It is another object of the present invention to provide a cartridge case and a disc cartridge that can be reliably and smoothly loaded into a recording/reproducing apparatus or the like.

A cartridge case according to the present invention is constructed so as to be capable of enclosing an information medium inside a cartridge main body that includes a first shell and a second shell and is formed by placing the first shell and the second shell on one another, wherein cylindrical convex portions, each of which has a positioning reference hole formed in a central portion thereof, are erected on an inner surface of a main plate of the first shell, and insertion holes that allow positioning pins to be inserted into the positioning reference holes of the cylindrical convex portions are formed in a main plate of the second shell.

With the above cartridge case, by constructing the first shell so that cylindrical convex portions, in each of which a positioning reference hole is formed, are erected on an inner surface of a main plate of the first shell, and constructing the second shell so that insertion holes that allow positioning pins to be inserted into the positioning reference holes are formed in a main plate of the second shell, even if the second shell is placed on and attached to the first shell in a state where the second shell is slightly displaced relative to the first shell, the positioning reference holes into which the positioning pins are inserted will not be displaced and therefore the cartridge case can be correctly positioned relative to a recording/reproducing apparatus or the like without being affected by the attachment position of the second shell on the first shell. Accordingly, with a disc cartridge constructed by enclosing a disc-shaped information medium inside this cartridge case, it is possible to carry out disc access properly for the information medium inside the cartridge case that has been correctly positioned inside the recording/reproducing apparatus.

Also, the second shell may include two shell main bodies in each of which at least one of the insertion holes is formed, the shell main bodies may be capable of being separately attached to the first shell, and two cylindrical convex portions may be erected on the first shell at positions into which the positioning pins are capable of being inserted via the insertion holes. With this construction, even if there are slight fluctuations in the relative positional relationship of the shell main bodies attached to the first shell between individual products, it will still be possible to avoid a state where the positioning reference holes on the cartridge case are displaced. Accordingly, it is possible to correctly position the cartridge case with respect to a recording/reproducing apparatus or the like.

The cylindrical convex portions may be formed with outer diameters of the cylindrical convex portions set equal to inner diameters of the insertion holes. With this construction, when the second shell has been placed on (i.e., fitted onto) the first shell, the rim portions of the insertion holes touch (i.e., are in contact with) the circumferential surfaces of the cylindrical convex portions, thereby making it possible to avoid a situation where the second shell is fitted onto the first shell in a greatly displaced state. This means that it is possible to avoid a state where the maximum width and maximum length of the cartridge case exceed standard ranges due to the second shell being displaced with respect to the first shell. As a result, the cartridge case can be smoothly loaded into the recording/reproducing apparatus and can be reliably loaded to the recording/reproducing position.

Also, the cylindrical convex portions may be formed so that in a state where the first shell and the second shell have been placed on one another, front end surfaces of the cylindrical convex portions become flush with an outer surface of the main plate of the second shell. With this construction, it is possible to avoid a situation where base ends of the positioning pins contact the surface of the main plate of the first shell (i.e., the rim portions of the insertion holes), which would make it difficult to insert the front ends of the positioning pins as far as standard positions inside the positioning reference holes and also to avoid a situation where the cylindrical convex portions protrude from the main plate of the first shell and catch on various components and the like inside the recording/reproducing apparatus.

Another cartridge case according to the present invention is constructed so as to be capable of enclosing an information medium inside a cartridge main body that includes a first shell and a second shell and is formed by placing the first shell and the second shell on one another, wherein the second shell is constructed so as not to protrude from the first shell in at least a width direction of the cartridge main body when the second shell has been placed on the first shell. Note that the expression “width direction” in the present specification refers to a direction perpendicular to the direction in which the cartridge case is loaded into a recording/reproducing apparatus or the like. With this construction, even if the second shell is attached to (placed on) the first shell in a slightly displaced state, the second shell will not greatly jut out (or protrude out) from the first shell, and therefore a situation where the maximum width of the cartridge case exceeds the width of the first shell can be avoided. Accordingly, the cartridge case can be smoothly loaded into the recording/reproducing apparatus and can be reliably loaded to the recording/reproducing position.

With the other cartridge case, the second shell may include two shell main bodies that are capable of being attached to the first shell so that the shell main bodies are apart in a width direction of the first shell to form a disc access opening between the shell main bodies, and the shell main bodies may be formed so that a total of a standard width of the disc access opening along the width direction of the first shell, a length along the width direction of one of the shell main bodies, and a length along the width direction of another of the shell main bodies is shorter than a width of the first shell. According to this construction, even if both shell main bodies are attached to (placed on) the first shell in a slightly displaced state, both shell main bodies will not greatly jut out (or protrude out) from the first shell, and therefore a situation where the maximum width of the cartridge case exceeds the width of the first shell can be avoided. Accordingly, the cartridge case can be smoothly loaded into the recording/reproducing apparatus and can be reliably loaded to the recording/reproducing position.

A disc cartridge according to the present invention is constructed by enclosing a disc-shaped information medium inside any of the cartridge cases described above.

It should be noted that the disclosure of the present invention relates to a content of Japanese Patent Application 2005-215510 that was filed on 26 Jul. 2005, the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a perspective view showing the appearance of a disc cartridge;

FIG. 2 is a side cross-sectional view of a vicinity of a cylindrical convex portion of the disc cartridge;

FIG. 3 is a plan view of the disc cartridge when looking from a lower shell side thereof;

FIG. 4 is a plan view of an upper shell when looking from an inner surface side thereof;

FIG. 5 is a plan view of a lower shell when looking from an outer surface side thereof;

FIG. 6 is a plan view of a cartridge case showing one example of a state where the lower shell (both lower shell main bodies) have been attached to the upper shell;

FIG. 7 is a side cross-sectional view of a vicinity of a cylindrical convex portion of another disc cartridge;

FIG. 8 is a side cross-sectional view of a vicinity of a cylindrical convex portion of yet another disc cartridge;

FIG. 9 is a perspective view showing the appearance of yet another disc cartridge; and

FIG. 10 is a plan view of a conventional disc cartridge.

### DESCRIPTION OF THE PREFERRED EMBODIMENTS

Preferred embodiments of a cartridge case and a disc cartridge according to the present invention will now be described with reference to the attached drawings.

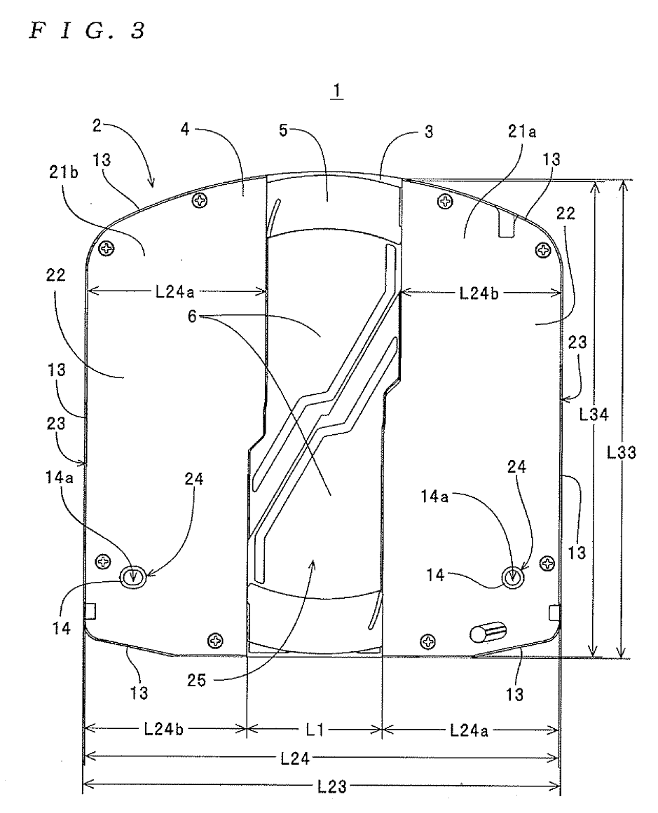

A disc cartridge 1 shown in FIGS. 7 to 3 is a cartridge-type information medium constructed so as to be capable of recording and reproducing various types of data, and is constructed so that a disc tray 5, a shutter member 6, and the like are enclosed together with an optical disc (one example of a “disc-shaped information medium” for the present invention: not shown) inside a cartridge case 2. The cartridge case 2 includes an upper shell 3 and a lower shell 4 formed so as to be capable of fitting together (i.e., capable of being placed on top of one another). Note that with the cartridge case 2, a “cartridge main body” for the present invention is constructed of a combination of the upper shell 3 and the lower shell 4.

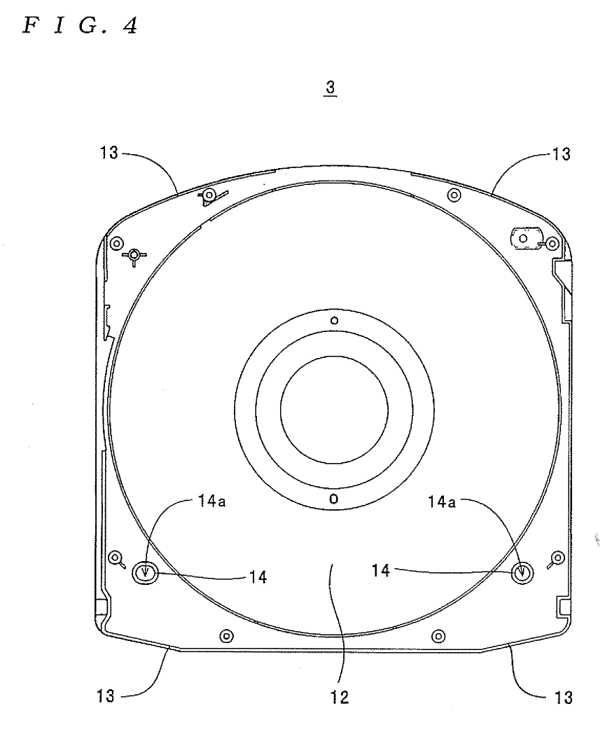

The upper shell 3 corresponds to a “first shell” for the present invention and as shown in FIG. 4, includes a top plate 12 corresponding to a “main plate” for the present invention, a side wall 13 that is erected at an outer edge of the top plate 12 and composes a side surface part of the cartridge case 2, and a partition wall that forms a disc enclosure inside the cartridge case 2, and as one example is injection-molded using light-transmitting polycarbonate. Two cylindrical convex portions 14 that have reference holes 14a used for positioning (hereinafter simply “reference holes 14a”) formed in central portions thereof are erected on an inner surface of the top plate 12 of the upper shell 3. For the disc cartridge 1, the formation positions of the cylindrical convex portions 14 are set corresponding to the positions of the second positioning portion 17x and the fourth positioning portion 19x of the conventional disc cartridge 1x. Also with the disc cartridge 1, the reference hole 14a of one cylindrical convex portion 14 (in FIG. 4, the cylindrical convex portion 14 on the right) is formed as a circular hole when viewed from above, and the reference hole 14a of the other cylindrical convex portion 14 (in FIG. 4, the cylindrical convex portion 14 on the left) is formed as an elliptical hole whose length is aligned with the width direction of the disc cartridge 1.

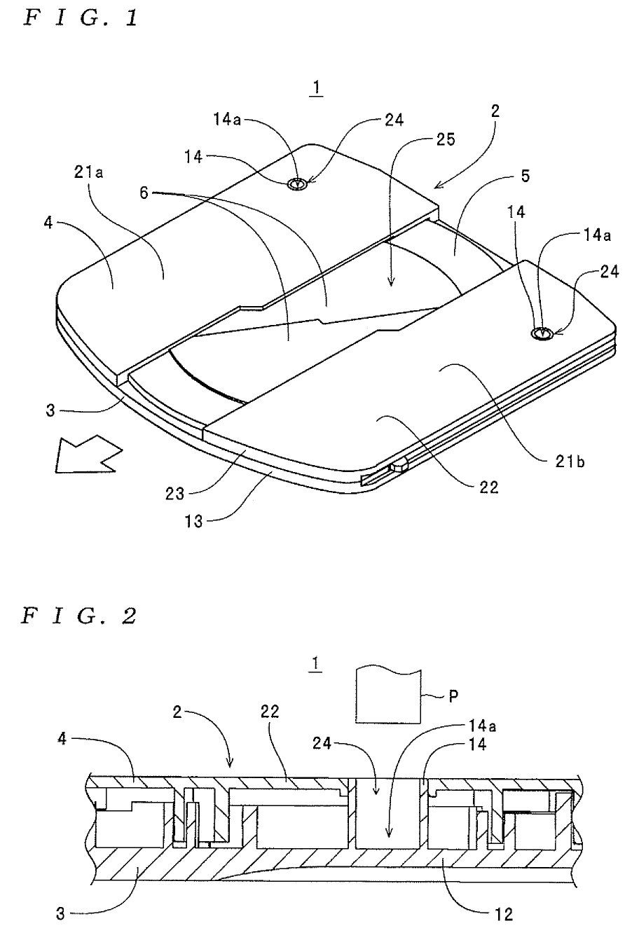

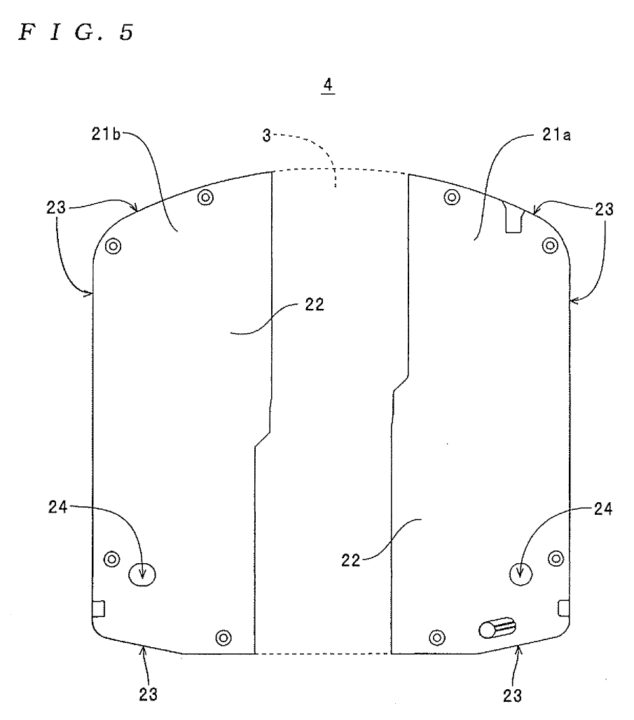

The lower shell 4 corresponds to a “second shells for the present invention. As shown in FIG. 5, the lower shell 4 includes a pair of lower shell main bodies 21a and 21b corresponding to “shell main bodies” for the present invention and as one example is injection-molded using a resin material such as polycarbonate or ABS resin. More specifically, the lower shell 4 (i.e., the lower shell main bodies 21a and 21b) includes baseplates 22 corresponding to a “main plate” for the present invention, a side wall 23 that is erected on the outer edge of the baseplate 22 and together with the side wall 13 of the upper shell 3 constructs the side surface part of the cartridge case 2, and a partition wall (not shown) that together with the partition wall of the upper shell 3 forms the disc enclosure inside the cartridge case 2. As shown in FIG. 1, in a state where the lower shell 4 has been fitted together with the upper shell 3 (i.e., where the lower shell 4 has been placed on and integrated with the upper shell 3), the lower shell 4 is disposed so that an opening 25 for disc access is formed between the baseplates 22 of the lower shell main bodies 21a and 21b. The width L1 (a “standard width” for the present invention: see FIG. 3), length, and the like of the opening 25 are set so that during the recording and reproducing of data, the opening 25 allows disc access (operations such as clamping by the recording/reproducing apparatus and irradiation with a laser beam via an optical head) to the optical disc inside the cartridge case 2.

Insertion holes 24 that enable positioning pins P (see FIG. 2) to be inserted into the reference holes 14a of the cylindrical convex portions 14 of the upper shell 3 are formed in the baseplates 22 of the lower shell main bodies 21a and 21b. On the disc cartridge 1, one of the insertion holes 24 (the insertion hole 24 on the right in FIG. 5) is formed as a circular hole when viewed from above, and the other insertion hole 24 (the insertion hole 24 on the left in FIG. 5) is formed as an elliptical hole whose length is aligned with the width direction of the disc cartridge 1. Also, with the disc cartridge 1, the respective outer diameters of the cylindrical convex portions 14 described above are set equal to the respective inner diameters of the insertion holes 24 formed in the lower shell 4 (the lower shell main bodies 21a and 21b). Accordingly, as shown in FIG. 2, in a state where the lower shell 4 (the lower shell main bodies 21a and 21b) is attached to the upper shell 3, rim portions of the insertion holes 24 contact circumferential surfaces of the cylindrical convex portions 14. Also, as shown in FIG. 2, with the disc cartridge 1, the heights of the cylindrical convex portions 14 are set so that when the shells 3 and 4 have been placed on one another, front end surfaces of the cylindrical convex portions 14 are flush with the outer surface of the baseplate 22 of the lower shell 4.

As shown in FIG. 3, the disc cartridge 1 is constructed so that in a state where the lower shell 4 has been placed on the upper shell 3, the lower shell 4 does not protrude from the upper shell 3 in the width direction of the cartridge case 2. More specifically, the size of the lower shell 4 and the assembled position of the lower shell 4 on the upper shell 3 are set so that the width L24 of the lower shell 4 is smaller than the width L23 of the upper shell 3. More specifically, the lower shell main bodies 21a and 21b are constructed so that the total (the width L24) of the opening width L1 (the standard width) along the width direction of the upper shell 3 of the opening 25 formed between the lower shell main bodies 21a and 21b, the length along the width direction of the lower shell main body 21a (as one example, the length L24a), and the length along the width direction of the lower shell main body 21b (as one example, the length L24b) is smaller than the width L23 of the upper shell 3. As a result, in a state where the lower shell main bodies 21a and 21b are placed on the upper shell 3 having been shifted inward so that the width of the opening 25 is the opening width L1 (i.e., the standard width), the distance (the width L24) along the width direction between the respective side walls 23 of the lower shell main bodies 21a and 21b will be smaller than the width L23 of the upper shell 3. The disc cartridge 1 is also constructed so that in a state where the lower shell 4 has been placed on the upper shell 3, the lower shell 4 does not protrude from the upper shell 3 in the length direction of the cartridge case 2 (i.e., the direction in which the disc cartridge 1 is inserted into a recording/reproducing apparatus). More specifically, the size of the lower shell main bodies 21a and 21b (i.e., the lower shell 4) is set so that the length L34 of the lower shell 4 is smaller than the length L33 of a corresponding part of the upper shell 3. In this way, with the cartridge case 2, the lower shell 4 (i.e., the lower shell main bodies 21a and 21b) is formed slightly smaller than the upper shell 3.

The disc tray 5 is formed of a circular plate-shaped baseplate and a side wall that is erected at an outer edge of the baseplate and is therefore in the shape of a shallow plate on which an optical disc can be mounted. The disc tray 5 is rotatably enclosed inside the cartridge case 2 together with the optical disc. An opening with substantially the same size as the opening 25 of the lower shell 4 is formed in the baseplate of the disc tray 5. The shutter member 6 is enclosed inside the cartridge case 2 so as to be sandwiched between the lower shell 4 and the disc tray 5 and is axially supported so as to be capable of rotating relative to the disc tray 5. As the disc tray S rotates relative to the cartridge case 2, the shutter member 6 and the baseplate of the disc tray 5 act in concert to cover or open the opening 25.

When assembling the disc cartridge 1, the lower shell main bodies 21a and 21b (the lower shell 4) is placed on the upper shell 3 in a state where the optical disc, the disc tray 5, the shutter member 6, and the like have been set on the upper shell 3. When doing so, as shown in FIG. 2, with the cartridge case 2, the lower shell main bodies 21a and 21b fit together with the upper shell 3 with the rim portions of the insertion holes 24 of the lower shell main bodies 21a and 21b touching (i.e., in contact with) the circumferential surfaces of the cylindrical convex portions 14 on the upper shell 3. Accordingly, the lower shell main bodies 21a and 21b are fitted together with the upper shell 3 without being greatly displaced. Next, as shown in FIG. 3, the lower shell main bodies 21a and 21b are screwed onto the upper shell 3.

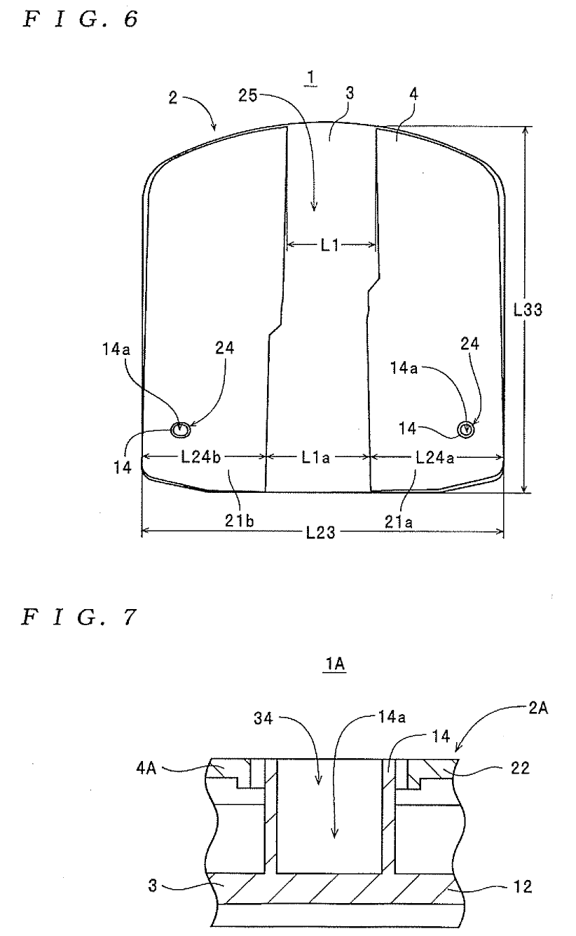

As described above, the sizes of the various parts of the lower shell main bodies 21a and 21b of the disc cartridge 1 are set so that the lower shell 4 is slightly smaller than the upper shell 3. Accordingly, as shown in FIG. 6, when the lower shell main bodies 21a and 21b are fitted together with the upper shell 3 (i.e., when the lower shell main bodies 21a and 21b have been placed on the upper shell 3), even if the lower shell main bodies 21a and 21b rattle on the upper shell 3 and due to this the lower shell main bodies 21a and 21b are screwed onto the upper shell 3 in a slightly displaced state (i.e., even if the lower shell main bodies 21a and 21b are screwed on so that the width L1a of the opening 25 is slightly wider than the opening width L1 that is the standard width), a state where the lower shell main bodies 21a and 21b greatly jut out (protrude out) from the upper shell 3 is avoided. This means that with the cartridge case 2, regardless of the posture in which the lower shell main bodies 21a and 21b are attached to the upper shell 3, the width L23 of the upper shell 3 will be the maximum width of the cartridge case 2 and the length L33 of the upper shell 3 will be the maximum length of the cartridge case 2. Note that in FIG. 6, for ease of understanding the present invention, the displacement of the lower shell main bodies 21a and 21b (i.e., the lower shell 4) with respect to the upper shell 3 has been exaggerated.

Since the reference holes 14a (the cylindrical convex portions 14) for positioning the disc cartridge 1 with respect to a recording/reproducing apparatus are formed on the upper shell 3 of the cartridge case 2, it is possible to always position the reference holes 14a at the same positions on the cartridge case 2 without being affected by the attachment position of the lower shell main bodies 21a and 21b on the upper shell 3. Accordingly, when the disc cartridge 1 is loaded into the recording/reproducing apparatus and the positioning pins P (see FIG. 2) are inserted from the lower shell 4 side via the insertion holes 24 into the reference holes 14a, the disc cartridge 1 will be correctly positioned at a predetermined recording/reproducing position inside the recording/reproducing apparatus.

In this way, according to the cartridge case 2 and the disc cartridge 1, by constructing the upper shell 3 by erecting the cylindrical convex portions 14 in which the reference holes 14a are formed on the inner surface of the top plate 12 and constructing the lower shell 4 (i.e., the lower shell main bodies 21a and 21b) so that the insertion holes 24 that enable the positioning pins P to be inserted into the reference holes 14a of the cylindrical convex portions 14 are formed in the baseplates 22, even if the lower shell 4 (i.e., the lower shell main bodies 21a and 21b) is placed on and attached to the upper shell 3 in a state where the lower shell 4 is slightly displaced with respect to the upper shell 3, there will be no displacement of the reference holes 14a into which the positioning pins P are inserted and therefore the disc cartridge 1 can be correctly positioned with respect to a recording/reproducing apparatus or the like without being affected by the attachment positions of the lower shell main bodies 21a and 21b on the upper shell 3. Accordingly, with the disc cartridge 1 where a disc-shaped information medium (in this example, an optical disc) is enclosed within the cartridge case 2 described above, disc access can be carried out properly for the optical disc inside the cartridge case 2 that is correctly positioned inside the recording/reproducing apparatus.

According to the cartridge case 2, by constructing the lower shell 4 so as to include the two lower shell main bodies 21a and 21b in which the insertion holes 24 are respectively formed and constructing the upper shell 3 so that the two cylindrical convex portions 14 are erected at positions at which the positioning pins P can be inserted via the insertion holes 24, even if there are slight fluctuations in the relative positional relationship of the lower shell main bodies 21a and 21b attached to the upper shell 3 between individual products, it will still be possible to avoid a state where the reference holes 14a on the cartridge case 2 are displaced. Accordingly, it is possible to correctly position the cartridge case 2 with respect to a recording/reproducing apparatus or the like.

In addition, according to the cartridge case 2, by forming the cylindrical convex portions 14 by setting the outer diameters of the cylindrical convex portions 14 equal to the inner diameters of the insertion holes 24, when the lower shell main bodies 21a and 21b have been placed on (i.e., fitted onto) the upper shell 3, the rim portions of the insertion holes 24 touch (i.e., are in contact with) the circumferential surfaces of the cylindrical convex portions 14, thereby making it possible to avoid a situation where the lower shell main bodies 21a and 21b are fitted onto the upper shell 3 in a greatly displaced state. This means that it is possible to avoid a state where the maximum width and maximum length of the cartridge case 2 exceed standard ranges due to the lower shell main bodies 21a and 21b being displaced with respect to the upper shell 3. As a result, the cartridge case 2 can be smoothly loaded into the recording/reproducing apparatus and can be reliably loaded to the recording/reproducing position.

Also, according to the cartridge case 2, since the cylindrical convex portions 14 are formed so that in a state where the shells 3 and 4 have been placed on each other, the front end surfaces of the cylindrical convex portions 14 are flush with the outer surface of the baseplate 22 of the lower shell 4, it is possible to avoid a situation where base ends of the positioning pins P contact the surface of the top plate 12 of the upper shell 3 (i.e., the rim portions of the insertion holes 24), which would make it difficult to insert the front ends of the positioning pins P as far as standard positions inside the reference holes 14a and also to avoid a situation where the cylindrical convex portions 14 protrude from the top plate 12 of the upper shell 3 and catch on various components and the like inside the recording/reproducing apparatus.

Also, with the cartridge case 2, the lower shell 4 is constructed so as not to protrude from the upper shell 3 in the width direction of the cartridge case 2 in a state where the lower shell 4 has been placed on the upper shell 3. More specifically, with the cartridge case 2, the lower shell main bodies 21a and 21b are constructed so that the total length (the width L24) of the standard width (the opening width L1) of the opening 25 along the width direction of the upper shell 3, the length L24a along the width direction of the lower shell main body 21a, and the length L24b along the width direction of the lower shell main body 21b is smaller than the width L23 of the upper shell 3. Accordingly, with the cartridge case 2, even if the lower shell main bodies 21a and 21b are attached to the upper shell 3 in a slightly displaced state, the lower shell main bodies 21a and 21b will not jut out (protrude out) from the planar region of the upper shell 3, and therefore it is possible to avoid a situation where the maximum width of the cartridge case 2 exceeds the width L23 of the upper shell 3 and a situation where the maximum length of the cartridge case 2 exceeds the length L33 of the upper shell 3. Accordingly, it is possible to smoothly load the cartridge case 2 into the recording/reproducing apparatus and to reliably load the cartridge case 2 as far as the recording/reproducing position.

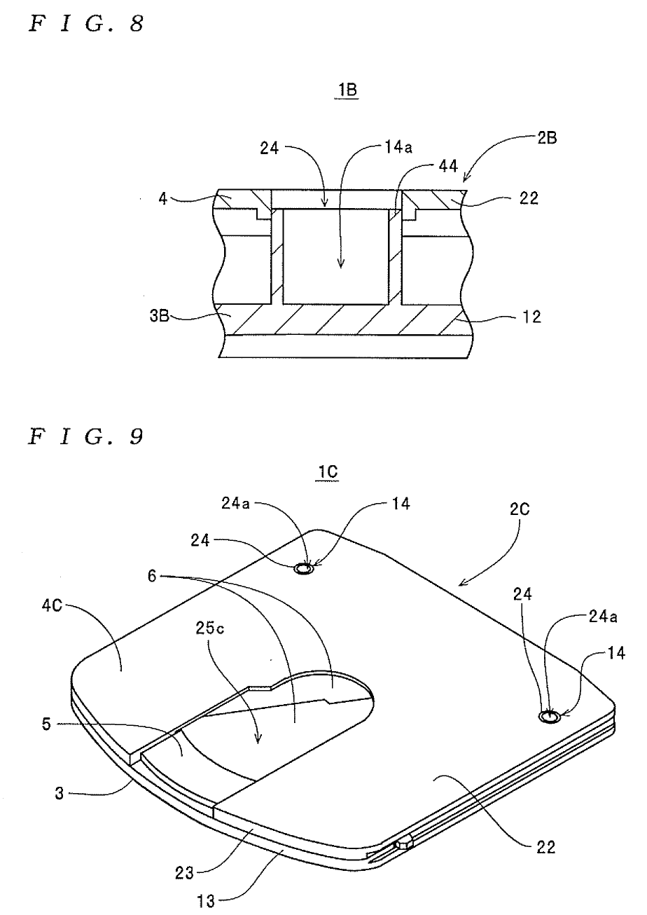

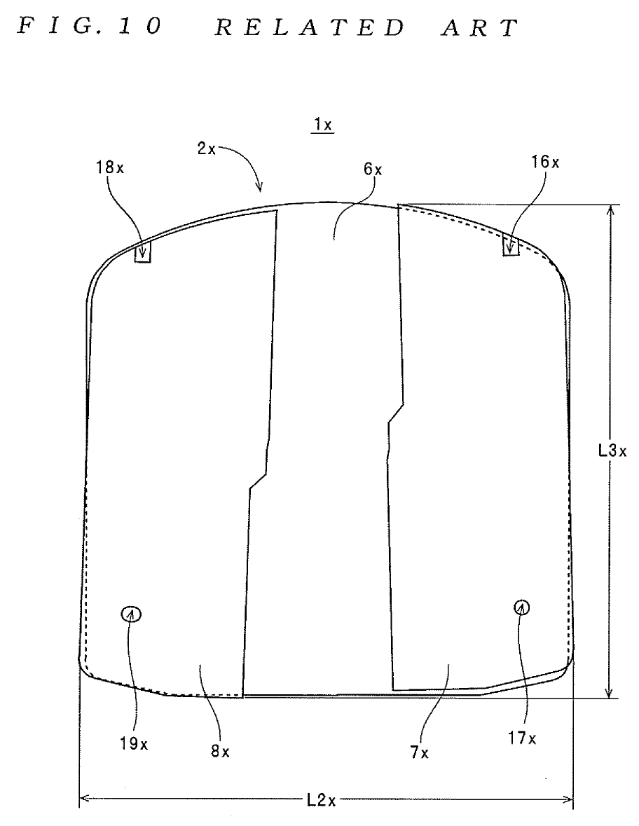

Note that the present invention is not limited to the construction described above. For example, although the outer diameters of the cylindrical convex portions 14 are set equal to the inner diameters of the insertion holes 24 with the disc cartridge 1 (or the cartridge case 2) described above, the present invention is not limited to this, and like a disc cartridge 1A (or a cartridge case 2A) shown in FIG. 7, for example, it is possible to form insertion holes 34 whose inner diameter is larger than the outer diameter of the cylindrical convex portions 14 in the baseplate 22 of a lower shell 4A (i.e., the lower shell main bodies 21a and 21b). Also, although with the disc cartridge 1 (or the cartridge case 2), the heights of the cylindrical convex portions 14 are set so that in a state where the lower shell main bodies 21a and 21b are placed on the upper shell 3, the front end surfaces of the cylindrical convex portions 14 become flush with the surface of the baseplates 22 of the lower shell main bodies 21a and 21b, the present invention is not limited to this, and like a disc cartridge 1B (or a cartridge case 2B) shown in FIG. 8, for example, it is possible to construct an upper shell 3B with the height of cylindrical convex portions 44 set so that the front end surfaces of the cylindrical convex portions 44 are lower than the surface of the baseplates 22 (i.e., so that the front end surfaces are positioned further inside the cartridge case 2B than the surface of the baseplates 22).

In addition, although the disc cartridge 1 described above is constructed so that the cartridge case 2 includes a lower shell 4 composed of separate lower shell main bodies 21a and 21b that can be attached to the upper shell 3, the present invention is not limited to this and like a disc cartridge 1C shown in FIG. 9, a cartridge case 2C may be constructed of the upper shell 3 and a single lower shell 4C. In this case, by setting the width of the lower shell 4C slightly narrower than the width of the upper shell 3, even if the lower shell 4C is attached in a displaced state on the upper shell 3, the lower shell 4C will not greatly jut out (protrude out) from the planar region of the upper shell 3, and therefore it is possible to avoid a situation where the maximum width of the cartridge case 2C exceeds the width of the upper shell 3. Also, by setting the length of the lower shell 4C slightly shorter than the length of the upper shell 3, even if the lower shell 4C is attached in a state where the lower shell 4C is displaced with respect to the upper shell 3, the lower shell 4C will not greatly jut out (protrude out) from the planar region of the upper shell 3, and therefore it is possible to avoid a situation where the maximum length of the cartridge case 2C exceeds the length of the upper shell 3. Accordingly, the cartridge case 2C can be smoothly loaded into the recording/reproducing apparatus and can be reliably loaded to the recording/reproducing position.

The shape of the opening for disc access formed in the second shell of the present invention is not limited to a rectangular shape that extends in the front-rear direction like the opening 25 of the cartridge case 2 of the disc cartridge 1 described above, and may be a rectangular shape that extends in the left-right direction of the cartridge case or a rectangular shape that extends in a diagonal direction for a cartridge case that is square. Also, like the opening 25C of the cartridge case 2C of the disc cartridge 1C shown in FIG. 9, the opening can be formed with a length substantially equal to the radius of the optical disc enclosed within the cartridge case 2C. The reference holes used for positioning in the present invention are not limited to holes like the reference holes 14a of the disc cartridge 1 where the base ends of the cylindrical convex portions 14 are covered by the top plate 12, and a round hole and an elliptical hole with the same shapes as the reference holes 14a may be provided in the top plate 12 so that the reference holes 14a pass through to the surface of the top plate 12.

The disc cartridge according to the present invention is not limited to a disc cartridge where an optical disc is enclosed inside a cartridge case 2 like the disc cartridge 1 described above, and it is possible to construct a disc cartridge by enclosing various types of disc-shaped information medium, such as a magneto-optical disc or a magnetic disc in place of the optical disc inside the cartridge case. In addition, the information medium enclosed inside the cartridge case according to the present invention is not limited to a disc-shaped information medium and includes various types of information medium, such as a tape-shaped information medium.

What is claimed is:

1. A cartridge case constructed so as to be capable of enclosing an information medium inside a cartridge main body that includes a first shell and a second shell and is formed by placing the first shell and the second shell on one another,
wherein cylindrical convex portions, each of which has a positioning reference hole formed in a central portion thereof, are erected on an inner surface of a main plate of the first shell, and
insertion holes that allow positioning pins to be inserted into the positioning reference holes of the cylindrical convex portions are formed in a main plate of the second shell.

2. A cartridge case according to claim 1,
wherein the second shell includes two shell main bodies in each of which at least one of the insertion holes is formed, and the shell main bodies are capable of being separately attached to the first shell, and
two cylindrical convex portions are erected on the first shell at positions into which the positioning pins are capable of being inserted via the insertion holes.

3. A cartridge case according to claim 1,
wherein the cylindrical convex portions are formed with outer diameters of the cylindrical convex portions set equal to inner diameters of the insertion holes.

4. A cartridge case according to claim 1,
wherein the cylindrical convex portions are formed so that in a state where the first shell and the second shell have been placed on one another, front end surfaces of the cylindrical convex portions become flush with an outer surface of the main plate of the second shell.

5. A cartridge case constructed so as to be capable of enclosing an information medium inside a cartridge main body that includes a first shell and a second shell and is formed by placing the first shell and the second shell on one another,
wherein the second shell is constructed so as not to protrude from the first shell in at least a width direction of the cartridge main body when the second shell has been placed on the first shell.

6. A cartridge case according to claim 5,
wherein the second shell includes two shell main bodies that are capable of being attached to the first shell so that the shell main bodies are apart in a width direction of the first shell to form a disc access opening between the shell main bodies, and
the shell main bodies are formed so that a total of a standard width of the disc access opening along the width direction of the first shell, a length along the width direction of one of the shell main bodies, and a length along the width direction of another of the shell main bodies is shorter than a width of the first shell.

7. A disc cartridge constructed by enclosing a disc-shaped information medium inside the cartridge case according to claim 1.

8. A disc cartridge constructed by enclosing a disc-shaped information medium inside the cartridge case according to claim 5.
